(19) United States
(12) Patent Application Publication
(10) Pub. No.: US 2023/0108883 A1
(43) Pub. Date: Apr. 6, 2023

(54) SYSTEMS AND METHODS FOR INCREASING HARDWARE ACCELERATOR PERFORMANCE IN NEURAL NETWORK APPLICATIONS

(71) Applicant: Maxim Integrated Products, Inc., San Jose, CA (US)

(72) Inventors: Mark Alan LOVELL, Lucas, TX (US); Robert Michael MUCHSEL, Addison, TX (US)

(73) Assignee: Maxim Integrated Products, Inc., San Jose, CA (US)

(21) Appl. No.: 17/494,422

(22) Filed: Oct. 5, 2021

(51) Int. Cl. G06N 3/063; G06F 9/50; G06F 9/48

(52) U.S. Cl. CPC G06N 3/063; G06F 9/5027; G06F 9/5094; G06F 9/4881

(57) ABSTRACT

Low-power systems and methods increase computational efficiency in neural network processing by allowing hardware accelerators to perform processing steps on large amounts of data at reduced execution times without significantly increasing hardware cost. In various embodiments, this is accomplished by accessing locations in a source memory coupled to a hardware accelerator and using a resource optimizer that based on storage availability and network parameters determines target locations in a number of distributed memory elements. The target storage locations are selected according to one or more memory access metrics to reduce power consumption. A read/write synchronizer then schedules simultaneous read and write operations to reduce idle time and further increase computational efficiency.

### BACKGROUND

### A. Technical Field

The present disclosure relates generally to data processing in machine-learning applications. More particularly, the present disclosure relates to systems and methods for increasing computational efficiency of hardware accelerators in machine learning applications.

### B. Background

Machine learning is a subfield of artificial intelligence that enables computers to learn by example without being explicitly programmed in a conventional sense. Numerous machine learning applications utilize a Convolutional Neural Network (CNN), i.e., a supervised network that is capable of solving complex classification or regression problems, for example, for image or video processing applications. A trained network can be fine-tuned to learn additional features. In an inference phase, the CNN uses unsupervised operations to detect or interpolate previously unseen features or events in new input data to classify objects, or to compute an output such as a regression. The CNN applies hierarchical network layers and sub-layers to the input image when making its determination or prediction. A network layer is defined, among other parameters, by kernel size. A convolutional layer may use several kernels that apply a set of weights to the pixels of a convolution window of an image. For example, a two-dimensional convolution operation involves the generation of output feature maps for a layer by using data in a two-dimensional window from a previous layer. As the amount of data subject to convolution operations increases and the complexity of operations continues to grow, the added steps of storing and retrieving intermediate results from memory to complete an arithmetic computation may reduce the efficiency of the system.

Accordingly, what is needed are low-power systems and methods that allow hardware accelerators, to efficiently perform a myriad of complex processing steps on large amounts of data at reduced execution times without significantly increasing hardware cost.

### BRIEF DESCRIPTION OF THE DRAWINGS

References will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments. Items in the figures are not to scale.

FIG. 1 shows a conventional embedded machine learning accelerator system.

FIG. 2 illustrates a machine learning system using a hardware accelerator with improved performance according to embodiments of the present disclosure.

FIG. 3 is a flowchart of an illustrative process for using a resource optimizer to increase hardware accelerator performance in neural network applications according to embodiments of the present disclosure.

FIG. 4 is a flowchart of a process for using a read/write synchronizer to increase hardware accelerator performance in neural network applications according to embodiments of the present disclosure.

FIG. 5 depicts a simplified block diagram of a computing device/information handling system, in accordance with embodiments of the present disclosure.

### DETAILED DESCRIPTION OF EMBODIMENTS

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be implemented in a variety of ways, such as a process, an apparatus, a system, a device, or a method on a tangible computer-readable medium.

Components, or modules, shown in diagrams are illustrative of exemplary embodiments of the invention and are meant to avoid obscuring the invention. It shall also be understood that throughout this discussion that components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” or “communicatively coupled” shall be understood to include direct connections, indirect connections through one or more intermediary devices, and wireless connections.

Reference in the specification to “one embodiment,” “preferred embodiment,” “an embodiment,” or “embodiments” means that a particular feature, structure, characteristic, or function described in connection with the embodiment is included in at least one embodiment of the invention and may be in more than one embodiment. Also, the appearances of the above-noted phrases in various places in the specification are not necessarily all referring to the same embodiment or embodiments.

The use of certain terms in various places in the specification is for illustration and should not be construed as limiting. A service, function, or resource is not limited to a single service, function, or resource; usage of these terms may refer to a grouping of related services, functions, or resources, which may be distributed or aggregated.

The terms “include,” “including,” “comprise,” and “comprising” shall be understood to be open terms and any lists the follow are examples and not meant to be limited to the listed items. Any headings used herein are for organizational purposes only and shall not be used to limit the scope of the description or the claims. Each reference/document mentioned in this patent document is incorporated by reference herein in its entirety.

It shall be noted that embodiments described herein are given in the context of embedded machine learning accelerators, but one skilled in the art shall recognize that the teachings of the present disclosure are not so limited and may equally reduce power consumption in related or other devices.

In this document the terms “memory,” “memory device,” and “register” are used interchangeably. Similarly, the terms kernel, filter, weight, parameter, and weight parameter are used interchangeably. The term “layer” refers to a neural network layer. “Neural network” includes any neural network known in the art. The term “hardware accelerator” refers to any electrical or optical circuit that may be used to perform mathematical operations and related functions, including auxiliary control functions. “Circuit” includes “sub-circuits” and may refer to both custom circuits, such as special hardware, and general purpose circuits.

As used herein, the term “in-flight” refers to operations that are performed in an inbound data path, e.g., from a source memory to a hardware circuit that performs convolution operations. “Element-wise operations” comprise operations that represent mathematical computations, such as additions, subtractions, multiplications, and logical operators, such as AND, OR, XOR, etc.

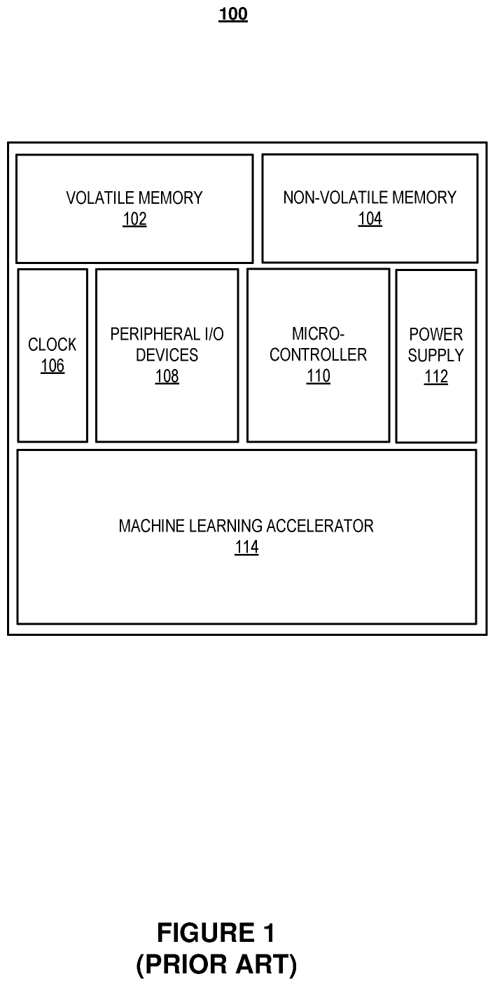

FIG. 1 illustrates a conventional embedded machine learning accelerator system that processes data in multiple stages. System 100 contains volatile memory 102, non-volatile memory 104, clock 106, clock I/O peripherals, microcontroller 110, power supply 112, and machine learning accelerator 114. Microcontroller 110 can be a traditional DSP or general-purpose computing device, machine learning accelerator 114 can be implemented as a CNN accelerator that comprises a large amount of registers (not shown). As depicted in FIG. 1, machine learning accelerator 114 interfaces with other parts of embedded machine learning accelerator system 100.

In operation, microcontroller 110 performs arithmetic computations in software. Machine learning accelerator 114 typically uses weight data to perform matrix-multiplications and related convolution computations on input data to which weight data is applied. The weight data may be unloaded from accelerator 114, for example, to load new or different weight data prior to accelerator 114 performing a new set of operations using the new set of weight data. More commonly, the weight data remains unchanged, and each new computation comprises new input data being loaded into accelerator 114 to perform computations.

Machine learning accelerator 114 lacks hardware acceleration for at least some of the possible neural network computations. These missing operators are typically emulated in software by using software functions embedded in microcontroller 110. However, such approaches are very costly in terms of both power and time; and for many computationally intensive applications, such as real-time applications, general purpose computing hardware is unable to perform the necessary operations in a timely manner as the rate of calculations is limited by the computational resources and capabilities of existing hardware designs.

Further, using arithmetic functions of microcontroller 110 to generate intermediate results comes at the expense of computing time due to the added steps of transmitting data, allocating storage, and retrieving intermediate results from memory locations to complete an operation. For example, many conventional multipliers are scalar machines that use CPUs or GPUs as their computation unit and use registers and a cache to process data stored in non-volatile memory, relying on a series of software and hardware matrix manipulation steps, such as address generation, transpositions, bit-by-bit addition and shifting, converting multiplications into additions and outputting the result into some internal register. In practice, these repeated read/write operations performed on a significant amount of weight parameters and input data with large dimensions and/or large channel count typically result in undesirable data movements in the data path and, thus, increase power consumption.

Existing neural network systems both load into memory and process input data, such as image or audio data, indiscriminately regardless of content or format, i.e., without considering properties of the input data. However, in many instances not all data that is loaded is also processed. Moreover, the data that is processed is typically processed in a predetermined sequential manner, e.g., in a predetermined order of layers of a fixed neural network, based on a network model that has been trained in a specific way. The rigidity of handling large amount of data in this traditional way results in many unnecessary preparatory computing steps that consume valuable computing resources and slow down calculation. The computational complexity involved in convolutions and other operations performed by CNNs and power consumption associated therewith makes more efficient hardware acceleration and power-saving particularly desirable.

Accordingly, what is needed are flexible systems and methods that can intelligently load and process data in neural networks to optimize the use of available computational resources, such as memory, and reduce power consumption without negatively affecting the overall operation or performance.

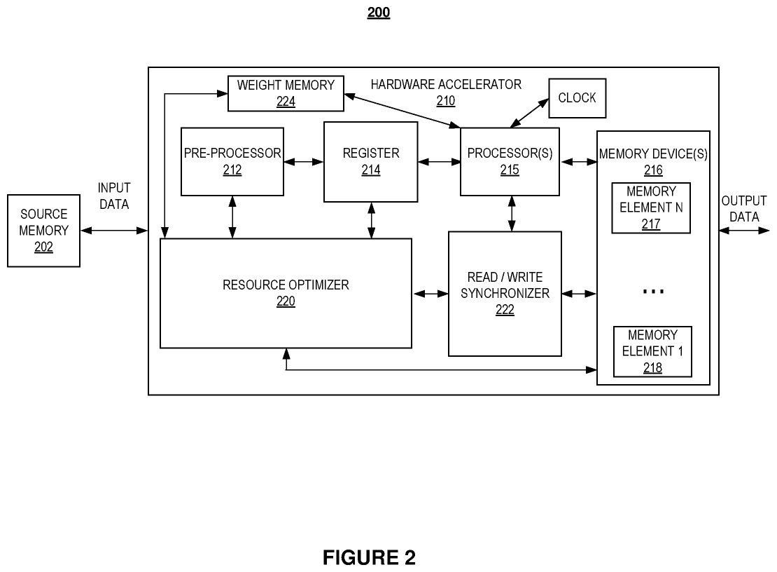

FIG. 2 illustrates a machine learning system for processing a neural network using distributed memory according to embodiments of the present disclosure. In embodiments, system 200 comprises source memory 202, hardware accelerator 210, resource optimizer 220, and read/write scheduler 222. Hardware accelerator 210 may be implemented as a single hardware accelerator architecture and, in operation, performs computations for various layers of a neural network model, e.g., a user-defined CNN. Source memory 202 may be any type of memory known in the art that may store input data 204, such as image or audio data depending on a particular application. As depicted, hardware accelerator may 210 comprise pre-processor 212, register(s) 214, processor(s) 215, memory 216, and weight memory 224.

In embodiments, memory 216 may be a main data memory that has been partitioned into different segments or RAM instances or a combination of individual memory elements (e.g., 217), which may comprise any number of independent configurable buffers, registers, or memory modules (e.g., memory element 217) that may be allocated for output channel generation. In embodiments, each memory element may be assigned to a set of processors 215 that may store (e.g., for each processing stage) input and output data generated by a specific layer of a CNN. Registers 214 may be implemented as any buffer or cache for storing any number of configuration or network parameters that may depend on both the input data and particular characteristics of network layers, such as filter size/widths, stride size, number of output channels, etc. In embodiments where weight memory 224 is combined with registers 214, registers 214 may comprise weight data. A person of skill in the art will appreciate that weight memory 224 may further comprise specialized memory, such as bias memory.

In embodiments, processor(s) 215 may be implemented as a set of computing circuits that comprise a combination of any number of multipliers, adders, shifters, accumulators, sub-samplers, cycle counters, and logic gates (not shown in FIG. 2). Computing circuits may be reconfigurable modular circuits that may be arranged in any combination to perform any number of computational tasks. Accumulators may accumulate, e.g., partial dot products for each output channel prior to selectively writing out data into memory 216 based on a set of criteria that may comprise any combination of type of operation, order of processing steps, memory efficiency metrics, and so on.

Since arithmetic computations for neural networks are highly deterministic and can be mathematically described as mostly linear algebra, many functions of machine learning system 200 may be anticipated at least for a given period of time even if the size of an input layer may be unknown. Knowing the relationship between input and output formats and the extent of calculations and making reasonable assumptions about the mathematical properties of the input data, computing resources, such as memory space for loading and storing data, may be pre-calculated and used more efficiently. As long as connectivity patterns are maintained, different implementations of otherwise mathematically equivalent solutions can thus result in significantly more efficient implementations with higher throughputs. Therefore, taking into account not only the constraints but also the availability of resources at any moment in time may guide the design and computations of a neural network (e.g., stride size to produce a feature map, kernel size, number of layers for an n-dimensional convolution, etc.) to fully exploit available resources to reduce runtime and increase computational efficiency when processing a CNN or other neural network.

In in embodiments, hardware accelerator 210 may obtain input data 204 having any arbitrary dimensionality that may have been stored in source memory 202 as a multi-dimensional array and may convert input data 204 into a vector for purposes of a linear transformation, e.g., to perform a discrete convolution operation that reuses known weight parameters. Similar to reusing weights, pre-processor 212 may use a cache or buffer (not shown in FIG. 2) to store a local copy of at least some of input data 204 (e.g., only once) for reuse by a the convolution operation without having to re-access and read data from source memory 202, thereby, reducing power consumption and data latency. In embodiments, to further leverage data-sharing and reduce access time and/or power consumption, pre-processor 212 may identify and reuse, e.g., redundant data within input data 204.

In embodiments, pre-processor 212 may take into account the size of input data 204 (e.g., image size) and other network parameters when preparing input data 204 for processing by hardware accelerator 210. Pre-processor 212 may be used to present preprocessed data to a 3×3 receptive field. In embodiments, pre-processor 212 may dynamically adjust and/or pre-format network configuration data and weights obtained from various locations, such that hardware accelerator 210 may fetch such data only once prior to processing and storing it in memory 216. For example, in embodiments, pre-processor 212 may reformat input data 204 on the fly, e.g., in consecutive clock cycles, to make input data 204 available for immediate execution by hardware accelerator 210 e.g., to apply weights element-wise to the receptive field, i.e., in a sum-of-products operation that dot multiplies some of the input data 204 and weight data generating element-wise products to commence generating output channels. Multiplied and added data from any number of processors 215 may be written into memory 216 at the same time.

Ideally, in every clock cycle data is moved from the input to the output since clocking an electrical circuit is associated with a fixed overhead cost in terms of time and power, especially by accessing data since, to a first order, energy is proportional to the number of reads and writes, i.e., the number memory access operations, whereas, in comparison, memory leakage is mainly a function of time. Thus, it is desirable to increase read, write, and other processing operations at every clock cycle as much as possible to keep the portion of computational overhead cost relatively low to increase efficiency.

In embodiments, pre-processor 212 may utilize in-flight pooling as disclosed in U.S. patent application Ser. No. 16/590,258, entitled, “Energy-Efficient Tornado Memory Systems and Methods,” filed on Oct. 1, 2019, and listing as inventors Mark Alan Lovell and Robert Michael Muchsel, which patent document is incorporated by reference herein in its entirety for all purposes, e.g., to read, in a single clock cycle, data from several locations to generate and write pooling data while data is being transferred from source memory 202 and before it is written out, thus, causing pre-processor 212 to act as a pooling unit that may pool (e.g., max pool or average pool) several pixels without requiring multiple access steps.

It is understood that, in embodiments, processing efficiency may be significantly increased if access times for performing reading operations is about equal to the time for performing writing operations, thereby, reducing idle time and energy. As a person of skill in the art will appreciate, even if in certain embodiments peak power may increase when data is read simultaneously or in parallel from more than one memory device, due to the achieved time savings, the overall power consumption may significantly decrease.

In embodiments, processor 215 may be split into a number of instances such that two or more processors may concurrently apply two or more kernels, which may have been independently retrieved from two or more weight memories 224 (or a single weight memory 224 that has been partitioned into two or more segments), to a given receptive field, e.g., in a single clock cycle, to generate two or more output channels in parallel. It is noted that output channels may be generated from intermediate outputs without generating a CNN output in each clock cycle. In embodiments, the output data may be written into two or more different memory elements. As a result, for four exemplary processors 215 four times the amount of information may be written by a single physical processor. However, this is not intended as a limitation on the scope of the present disclosure since processor 215 and memory 216 may be divided into any arbitrary combination. In embodiments, one kernel may be applied to two or more independent receptive fields to generate two or more output channels, while, at the same time, reading data to be calculated in a subsequent clock cycle, such as the next block of pixels.

In embodiments, data may be parallelly processed in hardware and then combined in the time domain, e.g., via time-division multiplexing or other time slicing methods. As an example, one physical processor 215 that comprises 64 physical local processors, each processor communicatively coupled with memory 216, may process 64 channels of data. In embodiments, processor 215 may use 64 physical local processors to process up to 16 channels of data over 16 cycles of time, thereby, creating 16 virtual processors. It is understood that, processors 215 may comprise local memory and share the same basic architecture and logic that may reused over time and repurposed for different output channels.

In embodiments, time slots may be repurposed in a number of ways. For example, instead of processing four output channels simultaneously, the same resources may be used to process 16 times the number of input channels. Further, in embodiments, by switching between modes, resources may be shared between processing input channels and generating output channels. As an example, assuming four input channels, e.g., RGB and IR are received from a video or image sensor at a neural network layer, instead of utilizing only four of the 64 processors and allowing the remaining processors to remain in an idle state, the remaining processors may be used to simultaneously process output channels to write out data about 16 times faster.

Faster processing not only allows for reduced execution times, it also reduces leakage losses, advantageously, leading to a better utilization of computational resources while reducing power consumption. It is understood that the utilization of shared resources should be taken into account when resources are allocated. It is further understood that, in embodiments, resource optimizer 220 may power down or place into a low-power mode certain resources, e.g., those that can be relatively easily and/or quickly re-activated, to further decrease power consumption when processing a network.

In embodiments, resource optimizer 220 may be implemented as a controller circuit, preprocessing software, state machine, or any combination thereof that is coupled to memory 202, 216, and 224 and that may comprise circuitry for memory organization, including estimating locations and availability or read/write memory.

In embodiments, resource optimizer 220 may comprise a selection unit for dynamically and strategically selecting, allocating, or reusing target read and write memory locations, e.g., based on parameters such as performance metrics, which may comprise calculated, measured, or estimated/expected values, such as a write cost per byte, input data dimensions or read size in bytes, number of channels, configuration parameters (e.g., per layer), data structure parameters of the network to be processed, and so on. In embodiments, suitable parameters may be derived from a memory access estimation model or reusability analysis, where the number of memory accesses may be expressed, e.g., as a cost of writing to and/or reading from memory. Resource optimizer 220 may further comprise comparators, dividers, and similar circuitry, e.g., for dividing the input data into discrete portions to be processed by read/write scheduler 222, or for comparing memory availability to maximum required memory access sizes for a layer as determined by resource optimizer 220.

In embodiments, to increase computation efficiency, unlike for traditional microprocessors or general purpose accelerators, resource optimizer 220 may make unique decisions that consider memory layout and information about the availability of source memory 202, weight memory 224, and memory 216 and configuration parameters at any given time, such as the type of a neural network layer to be processed, specific operations to be performed on the layer, a desired accuracy, and other information related to the processed network, including the properties of the data that is to be read and/or written and unique data-dependent properties and design constraints for specific neural network layers.

In embodiments, resource optimizer 220 may obtain information from which a number of memory access steps may be derived, estimated, or otherwise determined that are required to process at least part of a neutral network layer. Based on this layer-specific information, resource optimizer 220 may then determine or assign read and/or write memory locations and communicate those locations to read/write scheduler 222 to enable read/write scheduler 222 to schedule synchronized read/write operations at various locations at the same time, e.g., to generate multiple output maps, ideally, in a single clock cycle to enable partial or full parallel processing to further accelerate computations.

In embodiments, scheduling memory operations may comprise specifying sequences of computational and read/write operations for processing a particular network layer. Since different layers have different sizes and configuration parameters, each network layer typically has specific computational and memory demands that affect power requirements. In embodiments, each processor 215 may thus be configured to process one specific type of network layer, e.g., according to the demands of that network layer, to reduce memory access steps.

In embodiments, resource optimizer 220 may generate or utilize a memory layout that allows storing results and intermediate results, e.g., an output map generated by a preceding network layer in one memory element (e.g., memory element 217) that is presented in a modified format as an input to a current layer in another memory element (e.g., memory element 218). In embodiments, to enable synchronized read/write operations, resource optimizer 220 may modify configuration data in register 214, e.g., to appropriately align data formats. For example, resource optimizer 220 may perform steps comprising reformatting, reshaping, or rewriting data, which may comprise flattening data, e.g., to obtain a multi-dimensional vector or sparse matrix and reshaping flattened data into a multidimensional matrix, for example to obtain a higher dimensional output matrix and transform a convolution into a matrix operation.

In embodiments, resource optimizer 220 may enable processor 215 to perform arithmetic operations, such as transposing matrices to enable or simplify, e.g., forward propagation or backpropagation. Unlike existing systems that emulate convolutions or perform other indirect calculation methods, embodiments herein may thus decrease memory footprint and result in more efficient implementations. In addition, resource optimizer 220 may estimate or evaluate potential power savings that may be obtained from choosing one execution path over another.

For example, resource optimizer 220 may evaluate how much time would be spend in one stage versus another stage to decide whether it is warranted to automatically switch from one network path to another, activate a certain feature, or enable some other action. A suitable evaluation method may comprise performing calculations related to an optimization function that involves one or more metrics, such as time, number of clock cycles per event, number of read and writes, peak energy use, power consumption, amount of data, latency, and so on. In embodiments, an optimization function may comprise a formula, e.g., a formula that uses a ratio of read-to-write steps, i.e., a ratio of writing to and/or reading from memory, per clock cycle that may be affected by one or more configuration parameters, or any other relationship that may describe an efficiency metric for memory use.

In embodiments, read/write scheduler 222 may use a multiplexing circuit to schedule or coordinate read/write operations according to a scheduling scheme that considers information about storage capacity and available locations in memory devices 216 and 224 for each layer, as determined by resource optimizer 220.

In embodiments, resource optimizer 220 may evaluate a number of network parameters, such as weights, accuracy, and configuration parameters retrieved from register 214, e.g., to determine a minimum and maximum memory availability to store results (or partial results) for a particular set of successive operations associated with a particular network layer. For example, resource optimizer 220 would know that storing reusable kernel values in weight memory 224 for feature extraction requires less space than storing weight values for each fully connected neuron for classification operations.

In embodiments, resource optimizer 220 may map address spaces, e.g., by start locations and relative addresses or absolute address coordinates at which data should be accessed when reading or writing data. A suitable mapping may properly align data that is processed according to the network model and discard or overwrite non-used data. Instead of processing input data in a sequential manner, input data may be read from various memory locations, processed by two or more processors, and results may be output at various memory locations, e.g., according to available memory space.

In embodiments, output channel generation may be controlled by a different processor 215 (e.g., a state machine) than the reading process. Alternatively, the same state machine may process reads and writes in different states. It is noted that, in embodiments, resource optimizer 220 may overwrite areas of source memory 202 that are no longer required to store data for processing in subsequent layers. Conversely, some or all of the data in source memory 202 may be preserved, e.g., to calculate a new classification. In addition, resource optimizer 220 may determine whether certain calculation results that may have been previously obtained are available in memory 216 such that those results may advantageously be reused by processor 215 in a computation in the same or subsequent layer without having to re-compute and re-access at least some data.

It is understood that circuit machine learning 200 illustrated in FIG. 2 is not limited to the constructional detail shown there or described in the accompanying text. Those skilled in the art will appreciate that a suitable circuit may comprise different or additional elements and/or connections. For example, each component in system 200 may be controlled using suitable control signals, including clock signals, to communicate and collaborate with each other, e.g., over a system bus that operates at the same clock frequency.

It is further understood that various resources in system may be shared, e.g., memory element 217 may be shared by two or more processors. Components not explicitly shown in FIG. 2, may include output flip-flops or a state machine that may perform operations on output channels, a post processing circuitry, and any auxiliary devices that may aid in performing, e.g., management functions within machine learning system 200 that a person of skill would appreciate as being useful for accomplishing the goals of the present disclosure.

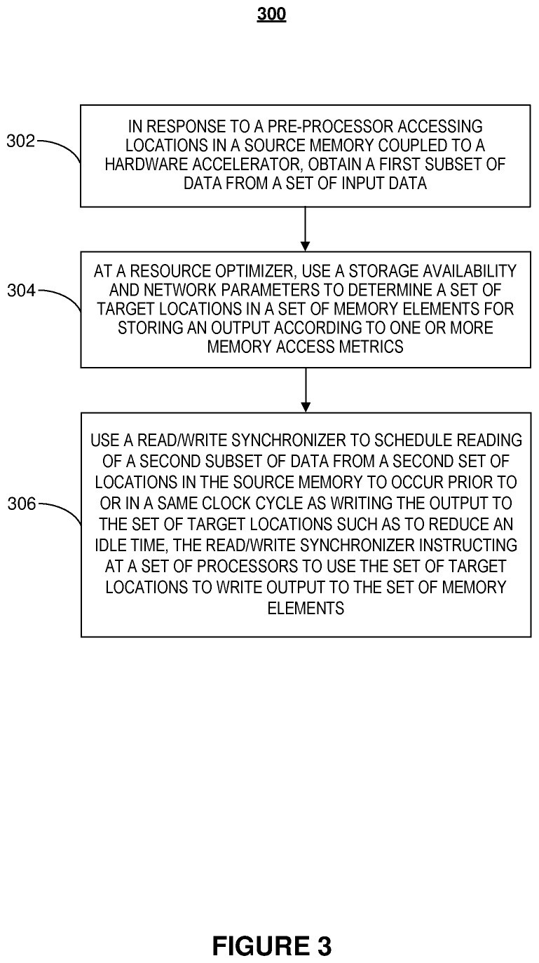

FIG. 3 is a flowchart of an illustrative process for using a resource optimizer to increase hardware accelerator performance in neural network applications according to embodiments of the present disclosure. In embodiments, process 300 for increasing hardware accelerator performance may begin, at step 302, when, a pre-processor accesses a first set of locations in a source memory that is coupled to a hardware accelerator, e.g., a convolutional neural network accelerator that performs one-dimensional or multi-dimensional convolution operations to generate output data. In embodiments, the hardware accelerator may perform inflight-pooling operations on the first subset of data.

The pre-processor may provide a first subset of data from a set of input data, e.g., previously unknown audio or image data, to a resource optimizer. At step 304, the resource optimizer may use at least one of a storage availability and one or more network parameters to determine a set of target locations in a set of memory elements for storing a first output, e.g., in a specific data format, according to one or more memory access metrics that may be derived by using a formula, an average, a region, an address range, a value range, or a memory access estimation model. In embodiments, the first output may be generated by a first neural network layer and serve as an input to a second neural network layer.

At step 306, the resource optimizer may use a read/write synchronizer to schedule reading of a second subset of data from a second set of locations in the source memory to occur prior to or in a same clock cycle as writing the first output to the set of target locations such as to reduce an idle time.

In embodiments, the read/write synchronizer, which may comprise a partition controller, may then instruct at a set of processors, which process the first subset of data to generate the first output, to use the set of target to write the first output to the set of memory elements. The read/write synchronizer may configure one or more registers in the hardware accelerator to properly allocate of target addresses, e.g., such that several pieces of data may be loaded and subsequently used without having to explicitly reconfigure target addresses, pointers, and the like.

In embodiments, the resource optimizer may synchronize read and write operations to enable the set of processors to perform a number of processing steps in parallel, wherein synchronizing may comprise evaluating potential power savings associated with at least one of the read operations or the write operations. In embodiments, the resource optimizer may use a correlation between the read and write operations to instruct the hardware accelerator to select one execution path over another or to change an order of processing.

One skilled in the art shall recognize that: (1) certain steps herein may optionally be performed; (2) steps may not be limited to the specific order set forth herein; (3) certain steps may be performed in different orders; and (4) certain steps may be performed concurrently.

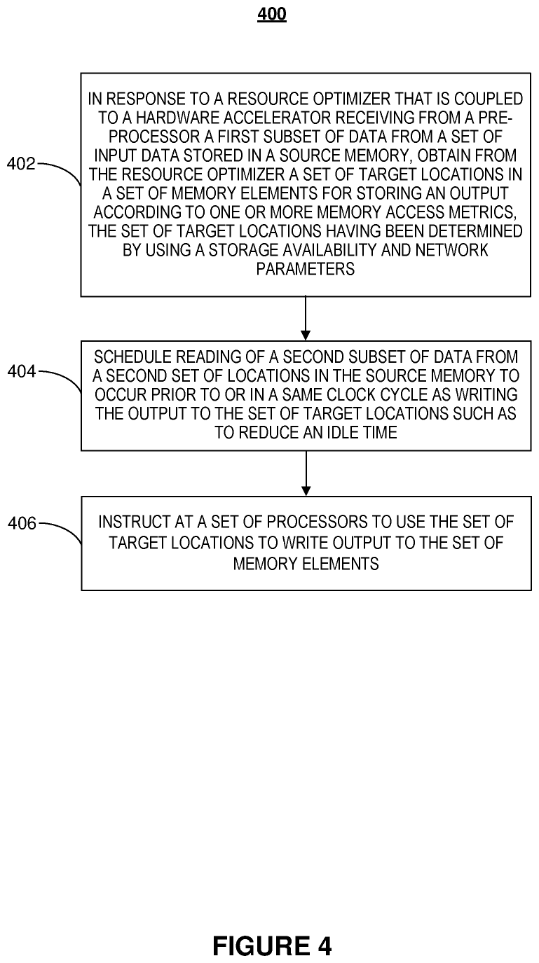

FIG. 4 is a flowchart of a process for using a read/write synchronizer to increase hardware accelerator performance in neural network applications according to embodiments of the present disclosure. In embodiments process 400 for increasing hardware accelerator performance may begin, at step 402, when, in response to a resource optimizer that is coupled to a hardware accelerator receiving from a pre-processor a first subset of data from a set of input data stored in a source memory, a read/write synchronizer obtains from the resource optimizer a set of target locations in a set of memory elements for storing an output according to one or more memory access metrics. The set of target locations may have been determined by using a storage availability and network parameters.

At step 404, the read/write synchronizer may schedule reading of a second subset of data from a second set of locations in the source memory to occur prior to or in a same clock cycle as writing the output to the set of target locations such as to reduce an idle time.

Finally, at step 406, the read/write synchronizer may instruct at a set of processors to use the set of target locations to write output to the set of memory elements.

In one or more embodiments herein, a stop condition may include: (1) a set number of iterations have been performed; (2) an amount of processing time has been reached; (3) convergence (e.g., the difference between consecutive iterations is less than a first threshold value); (4) divergence (e.g., the performance deteriorates); and (5) an acceptable outcome has been reached.

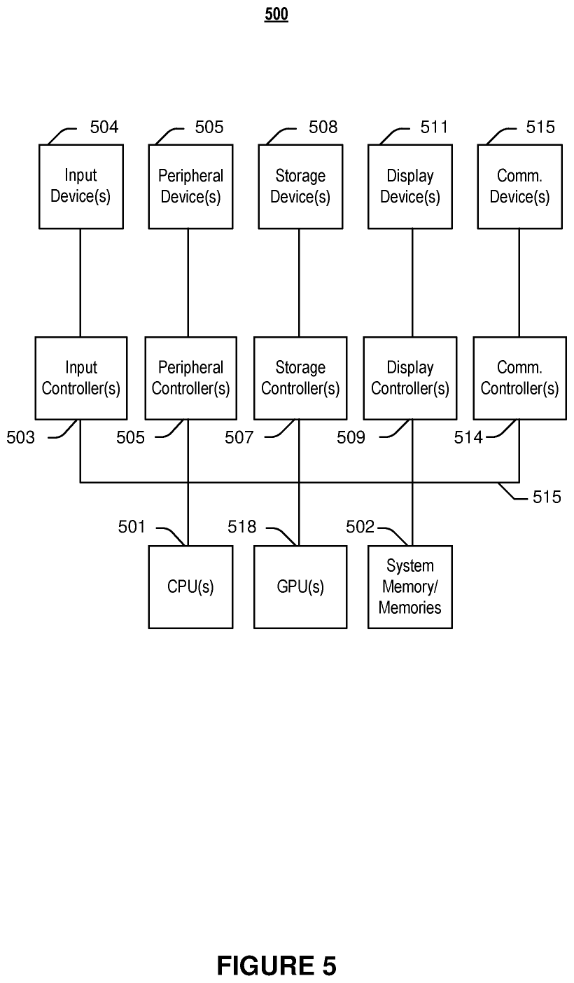

FIG. 5 depicts a simplified block diagram of an information handling system (or computing system) according to embodiments of the present disclosure. It will be understood that the functionalities shown for system 500 may operate to support various embodiments of a computing system—although it shall be understood that a computing system may be differently configured and include different components, including having fewer or more components as depicted in FIG. 5.

As illustrated in FIG. 5, the computing system 500 includes one or more CPUs 501 that provides computing resources and controls the computer. CPU 501 may be implemented with a microprocessor or the like, and may also include one or more graphics processing units 519 and/or a floating-point coprocessor for mathematical computations. System 500 may also include a system memory 502, which may be in the form of random-access memory (RAM), read-only memory (ROM), or both.

A number of controllers and peripheral devices may also be provided, as shown in FIG. 5. An input controller 503 represents an interface to various input device(s) 504, such as a keyboard, mouse, touchscreen, and/or stylus. The computing system 500 may also include a storage controller 507 for interfacing with one or more storage devices 508 each of which includes a storage medium such as magnetic tape or disk, or an optical medium that might be used to record programs of instructions for operating systems, utilities, and applications, which may include embodiments of programs that implement various aspects of the present disclosure. Storage device(s) 506 may also be used to store processed data or data to be processed in accordance with the disclosure. The system 500 may also include a display controller 509 for providing an interface to a display device 511, which may be a cathode ray tube (CRT), a thin film transistor (TFT) display, organic light-emitting diode, electroluminescent panel, plasma panel, or other type of display. The computing system 500 may also include one or more peripheral controllers or interfaces 505 for one or more peripherals 505. Examples of peripherals may include one or more printers, scanners, input devices, output devices, sensors, and the like. A communications controller 514 may interface with one or more communication devices 515, which enables the system 500 to connect to remote devices through any of a variety of networks including the Internet, a cloud resource (e.g., an Ethernet cloud, a Fiber Channel over Ethernet (FCoE)/Data Center Bridging (DCB) cloud, etc.), a local area network (LAN), a wide area network (WAN), a storage area network (SAN) or through any suitable electromagnetic carrier signals including infrared signals. Processed data and/or data to be processed in accordance with the disclosure may be communicated via the communications devices 515.

In the illustrated system, all major system components may connect to a bus 516, which may represent more than one physical bus. However, various system components may or may not be in physical proximity to one another. For example, input data and/or output data may be remotely transmitted from one physical location to another. In addition, programs that implement various aspects of the disclosure may be accessed from a remote location (e.g., a server) over a network. Such data and/or programs may be conveyed through any of a variety of machine-readable medium including, but are not limited to: magnetic media such as hard disks, floppy disks, and magnetic tape; optical media such as CD-ROMs and holographic devices; magneto-optical media; and hardware devices that are specially configured to store or to store and execute program code, such as ASICs, programmable logic devices (PLDs), flash memory devices, and ROM and RAM devices.

Aspects of the present disclosure may be encoded upon one or more non-transitory computer-readable media with instructions for one or more processors or processing units to cause steps to be performed. It shall be noted that the one or more non-transitory computer-readable media shall include volatile and non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present disclosure may further relate to computer products with a non-transitory, tangible computer-readable medium that have computer code thereon for performing various computer-implemented operations. The media and computer code may be those specially designed and constructed for the purposes of the present disclosure, or they may be of the kind known or available to those having skill in the relevant arts. Examples of tangible computer-readable media include, but are not limited to: magnetic media such as hard disks, floppy disks, and magnetic tape; optical media such as CD-ROMs and holographic devices; magneto-optical media; and hardware devices that are specially configured to store or to store and execute program code, such as ASICs, PLDs, flash memory devices, and ROM and RAM devices. Examples of computer code include machine code, such as produced by a compiler, and files containing higher level code that are executed by a computer using an interpreter. Embodiments of the present disclosure may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the present disclosure. One skilled in the art will also recognize that a number of the elements described above may be physically and/or functionally separated into sub-modules or combined together.

It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

What is claimed is:

1. A computer-implemented method for increasing hardware accelerator performance in neural network applications, the method comprising:
in response to a pre-processor accessing a first set of locations in a source memory coupled to a hardware accelerator, obtaining a first subset of data from a set of input data;
at a resource optimizer, using a storage availability and one or more network parameters to determine a first set of target locations in a set of memory elements for storing a first output according to one or more memory access metrics; and
using a read/write synchronizer to schedule reading of a second subset of data from a second set of locations in the source memory to occur prior to or in a same clock cycle as writing the first output to the first set of target locations such as to reduce an idle time, the read/write synchronizer instructing at a set of processors, which process the first subset of data to generate the first output, to use the first set of target to write the first output to the set of memory elements.

2. The computer-implemented method according to claim 1, wherein the hardware accelerator performs an inflight-pooling operation on the first subset of data.

3. The computer-implemented method according to claim 1, wherein the resource optimizer synchronizes read and write operations to enable the set of processors to perform a number of processing steps in parallel.

4. The computer-implemented method according to claim 3, wherein synchronizing comprises evaluating potential power savings associated with at least one of the read operations or the write operations.

5. The computer-implemented method according to claim 3, wherein the resource optimizer uses a correlation between the read and write operations to instruct the hardware accelerator to select one execution path over another or to change an order of processing.

6. The computer-implemented method according to claim 1, wherein at least one of the one or more network parameters or the one or more memory access metrics is used to determine a power consumption.

7. The computer-implemented method according to claim 1, wherein the hardware accelerator is a convolutional neural network accelerator that performs at least one of one-dimensional or two-dimensional convolution operations to generate output data by applying one or more of the network parameters to a neural network.

8. The computer-implemented method according to claim 1, wherein the first output is generated by a first neural network layer and serves as an input to a second neural network layer.

9. The computer-implemented method according to claim 8, wherein the resource optimizer uses the set of parameters to determine a second set of target locations in the set of memory elements for storing a second output associated with the second neural network layer.

10. The computer-implemented method according to claim 1, wherein the one or more memory access metrics are derived by using at least one of a formula, an average, a region, an address range, a value range, or a memory access estimation model.

11. The computer-implemented method according to claim 1, wherein the read/write synchronizer comprises a partition controller that assigns storage locations associated with one or more output channels.

12. A resource optimizer that increases hardware accelerator performance in neural network applications, the resource optimizer comprising:
one or more processors; and
a non-transitory computer-readable medium or media comprising one or more sets of instructions which, when executed by at least one of the one or more processors, causes steps to be performed comprising:
in response to a pre-processor accessing a first set of locations in a source memory coupled to a hardware accelerator, obtaining a first subset of data from a set of input data;
using a storage availability and one or more network parameters to determine a first set of target locations in a set of memory elements for storing a first output according to one or more memory access metrics; and
causing a read/write synchronizer to schedule reading of a second subset of data from a second set of locations in the source memory to occur prior to or in a same clock cycle as writing the first output to the first set of target locations such as to reduce an idle time, the read/write synchronizer instructing at a set of processors, which process the first subset of data to generate the first output, to use the first set of target locations to write the first output to the set of memory elements.

13. The resource optimizer according to claim 12, wherein the hardware accelerator performs an inflight-pooling operation on the first subset of data.

14. The resource optimizer according to claim 12, wherein the resource optimizer uses the set of parameters to determine a second set of target locations in the set of memory elements for storing a second output associated with the second neural network layer.

15. The resource optimizer according to claim 12, wherein at least one of the one or more network parameters or the one or more memory access metrics is used to determine a power consumption.

16. The resource optimizer according to claim 12, wherein the resource optimizer synchronizes read and write operations to enable the set of processors to perform a number of processing steps in parallel.

17. The resource optimizer according to claim 16, wherein synchronizing comprises evaluating potential power savings associated with at least one of the read operations or the write operations.

18. The resource optimizer according to claim 16, wherein the resource optimizer uses a correlation between the read and write operations to instruct the hardware accelerator to select one execution path over another or to change an order of processing.

19. The resource optimizer according to claim 12, wherein the set of input data comprises at least one of audio data or image data.

20. A non-transitory computer-readable medium or media comprising one or more sequences of instructions which, when executed by at least one processor, causes steps for increasing hardware accelerator performance in neural network applications comprising:
in response to a resource optimizer that is coupled to a hardware accelerator receiving from a pre-processor a first subset of data from a set of input data stored in a source memory, obtaining from the resource optimizer a set of target locations in a set of memory elements for storing an output according to one or more efficiency metrics, the set of target locations having been determined by using a storage availability and network parameters;
scheduling reading of a second subset of data from a second set of locations in the source memory to occur prior to or in a same clock cycle as writing the output to the set of target locations such as to reduce an idle time; and
instructing at a set of processors to use the set of target locations to write output to the set of memory elements.
